(19) United States
(12) Patent Application Publication
(10) Pub. No.: US 2021/0388866 A1
(43) Pub. Date: Dec. 16, 2021

(54) HIGH-CAPACITY MULTI-ROW WHEEL BEARING

(71) Applicant: Schaeffler Technologies AG & Co. KG, Herzogenaurach (DE)

(72) Inventor: Shakeel Shaikh, Windsor (CA)

(73) Assignee: Schaeffler Technologies AG & Co. KG, Herzogenaurach (DE)

(21) Appl. No.: 16/901,545

(22) Filed: Jun. 15, 2020

(51) Int. Cl. F16C 19/18; F16C 33/58

(52) U.S. Cl. CPC F16C 19/18; F16C 2326/02; F16C 33/583

(57) ABSTRACT

A wheel bearing has four rows of ball rollers. All four of the rows are at the same radius from an axis of rotation and have the same number of rollers. The bearing is assembled by inserting the rollers radially into raceways of a single piece outer ring and of two ring portions of a split inner ring. Then, the inner ring portions are assembled to the outer ring and to each other axially.

### TECHNICAL FIELD

The disclosure relates to the general field of vehicle wheel bearings. More particularly, the disclosure relates to a four-row wheel bearing in which all four rows may have approximately the same pitch diameters.

### BACKGROUND

FIG. 1 illustrates a four-row angular contact ball bearing suitable for use as a vehicular wheel bearing 10. The bearing utilizes a single-piece outer ring 12 and a split inner ring having a first ring portion 14 and a second ring portion 16. The outer ring is adapted for fixation to a non-rotating part of a vehicle suspension. The first inner ring portion includes a flange 18 suitable for mounting a rotatable wheel.

Four rows of ball rollers 20, 22, 24, and 26 separate the inner and outer rings. The dotted lines indicate lines of contact (contact angle). The lines of contact for the two rows on the left 20 and 22 are oriented in an opposite direction from the lines of contact for the two rows on the right 24 and 26. Note that the outer rows 20 and 26 are at a larger pitch radius than the inner rows 22 and 24. This facilitates assembly, but it results in sub-optimal performance. Since the inner rows 22 and 24 have a smaller radius, they do not have space for as many balls. Fewer balls results in less capacity, making the inner rows weak points for the overall bearing.

### SUMMARY

A multi-row bearing assembly includes an outer ring, a first inner ring, and first and second rows of rollers, such as balls. The outer ring (12′) defines first (36) and second (30) raceways. The first inner ring (14′) defines third (34) and fourth (38) raceways. The first row of rollers (20) is in angular contact with the first (36) and third (34) raceways. The rollers of the first row define a first outer radius and a first outer pitch radius with respect to the first raceway. The second row of rollers (22) is in angular contact with the second (30) and fourth (38) raceways. The rollers of the second row define a second outer radius and a second outer pitch radius with respect to the second raceway. Lines of action of the first and second rows of rollers are oriented in the same direction. The first outer radius exceeds the second outer pitch radius. The second outer radius exceeds the first outer pitch radius. The first and second rows may contain the same number of rollers. The first row of rollers may also define a first inner radius and a first inner pitch radius with respect to the third raceway. Similarly, the second row of rollers may also define a second inner radius and a second inner pitch radius with respect to the fourth raceway. The first inner pitch radius may exceed the second inner radius. The second inner pitch radius may exceed the first inner radius. A second inner ring (16′) may define a fifth (44) raceway. A third row of rollers (24′) may be in angular contact with the fifth raceway and a sixth (32) raceway defined by the outer ring. The rollers of the third row may define a third outer radius, a third inner radius, a third inner pitch radius with respect to the fifth raceway, and a third outer pitch radius with respect to the sixth raceway. A line of action of the third row of rollers may be oriented in an opposite direction from the lines of action of the first and second rollers. A fourth row of rollers (26′) may be in angular contact with a seventh (40) raceway defined by the second inner ring and with an eighth (42) raceway defined by the outer ring. The rollers of the fourth row may define a fourth outer radius, a fourth inner radius, a fourth inner pitch radius with respect to the seventh raceway, and a fourth outer pitch radius with respect to the eighth raceway. A line of action of the fourth row of rollers is oriented in an opposite direction from the lines of action of the first and second rollers. The third outer radius may exceed the fourth outer pitch radius. The fourth outer radius may exceed the third outer pitch radius. The third inner pitch radius may exceed the fourth inner radius. The fourth inner pitch radius may exceed the third inner radius. The first ring portion or the second ring portion may include a flange adapted for mounting a vehicle wheel.

A multi-row bearing assembly a single-piece ring, a split ring, and three rows of rollers. The single-piece ring (12′) defines first (36), second (30), and third (32) raceways. The split ring has a first (14′) and second (16′) ring portion. The first ring portion defines fourth (34) and fifth (38) raceways. The second ring portion defines a sixth (44) raceway. A first row of rollers (20′) is in angular contact with the first (36) and fourth (34) raceways. A second row of rollers (22′) is in angular contact with the second (30) and fifth (38) raceways. A third row of rollers (24′) is in angular contact with the third (32) and sixth (44) raceways. Lines of action of the first and second rows of rollers are oriented in an opposite direction from a line of action of the third row of rollers. Each row of rollers defines an inner and an outer pitch radius with respect to corresponding raceways. Each row also defines an inner radius and an outer radius. Each outer radius is greater than all of the outer pitch radii. Each inner radius is less than all of the inner pitch radii. The three rows of rollers may each contains the same number of rollers. A fourth row of rollers (26′) may be in angular contact with a seventh (42) raceway defined by the single piece ring (12′) and with an eighth (40) raceway defined by the second ring portion (16′). A line of action of the fourth row of rollers may be oriented in an opposite direction from the lines of action of the first and second rollers. The fourth row of rollers defines an outer radius greater than all of the outer pitch radii. The fourth row of rollers also defines an inner radius less than all of the inner pitch radii. One of the split ring portions may includes a flange adapted for mounting a vehicle wheel.

A method of assembling a multi-row angular contact bearing enables fabrication of the above bearing assemblies. A first set of rollers (22′) is inserted radially into a first (30) raceway of a single piece ring (12′). A second set of rollers (20′) is inserted radially into a second (34) raceway of a first ring portion (14′) of a split ring. The single piece ring and the first ring portion are then brought together such that the first set of rollers comes into contact with a third (38) raceway defined in the first ring portion (14′) and the second set of rollers (20′) comes into contact with a fourth (36) raceway defined in the single piece ring (12′). To assemble a three-row version, a second ring portion (16′) of the split ring is axially mated to the first ring portion (14′) such that a third row of rollers (24′) comes into contact with a fifth (32) raceway defined in the single-piece ring (12′) and with a sixth (44) raceway defined in the second ring portion (16). Additional steps are performed for a four-row version. A third set of rollers (24′) is radially inserted into a fifth (32) raceway of the single piece ring. A fourth set of rollers (26′) is radially inserted into a sixth (40) raceway of a second ring portion (16′) of the split ring. The second ring portion (16′) and the first ring portion (14′) are axially mated such that the third set of rollers (24′) comes into contact with a seventh (44) raceway defined in the second ring portion (16′) and the fourth set of rollers (26′) comes into contact with an eighth (42) raceway defined in the single piece ring (12′).

### BRIEF DESCRIPTION OF THE DRAWINGS

FIG. 1 is a cross section of a prior art four-row wheel bearing.

FIG. 2 is a cross section of an improved four-row wheel bearing.

FIG. 3 is an illustration of a first assembly step for the four-row wheel bearing of FIG. 2.

FIG. 4 is an illustration of a second assembly step for the four-row wheel bearing of FIG. 2.

FIG. 5 is an illustration of a third assembly step for the four-row wheel bearing of FIG. 2.

FIG. 6 is an illustration of a fourth assembly step for the four-row wheel bearing of FIG. 2.

FIG. 7 is an illustration of a final assembly step for the four-row wheel bearing of FIG. 2.

FIG. 8 is a cross section of an improved three-row wheel bearing.

FIG. 9 is an illustration of a first assembly step for the three-row wheel bearing of FIG. 8.

FIG. 10 is an illustration of a second assembly step for the three-row wheel bearing of FIG. 8.

FIG. 11 is an illustration of a final assembly step for the three-row wheel bearing of FIG. 8.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

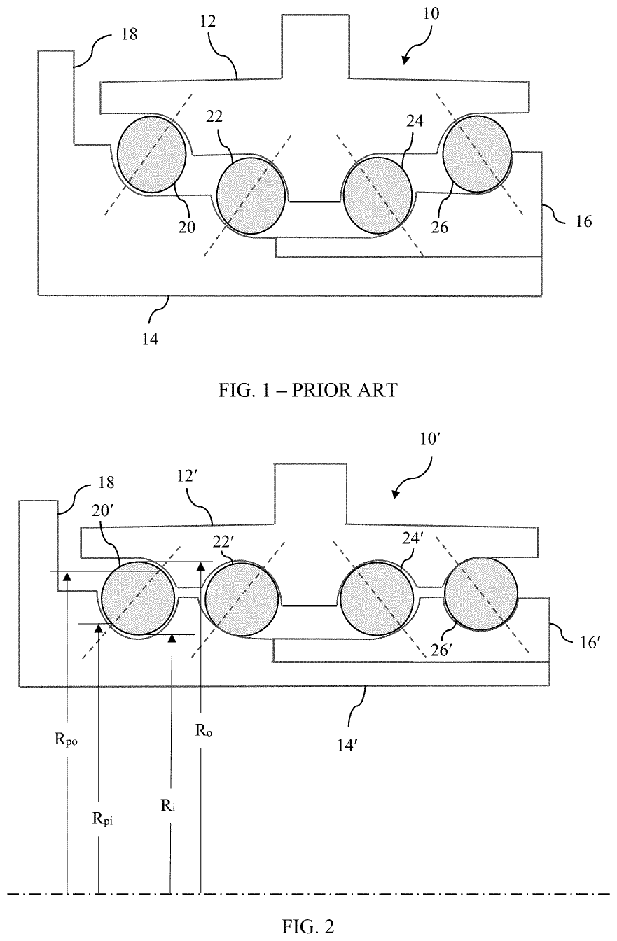

FIG. 2 illustrates an improved four-row angular contact ball bearing 10′. Parts which fulfill the same function as a part in the bearing of FIG. 1, but are not identical, are labelled with a primed reference number to indicate the correspondence. The inner radius, Rᵢ for a row of balls is defined as the distance from an axis of rotation to the closest surface of a ball. Similarly, the outer radius, Rₒ, for a row of balls is defined as the distance from the axis of rotation to the farthest surface of a ball. An inner pitch radius, Rₚᵢ, and an outer pitch radius, Rₚₒ, are defined as the distance from the axis of rotation to contact points on respective inner and outer races. Note that for any particular row of balls, Rᵢ<Rₚᵢ<Rₚₒ<Rₒ. Also note that in the design of FIG. 2, all four rows of balls, 20′ through 26′, have the same radii. Furthermore, all of the rows have the same number of balls and therefore the same capacity. The lines of action of rows 20′ and 22′ are oriented in the same direction. Being oriented in the same direction means that the inner and outer contact points are offset to the same side of vertical but not necessarily by the same amount. The lines of action of rows 24′ and 26′ are oriented in the same direction as each other but in an opposite direction from rows 20′ and 22′. For a given ball diameter, the radial size of the bearing assembly is narrower than the bearing assembly of FIG. 1. Therefore, for a given available packaging space, a higher overall capacity is achieved.

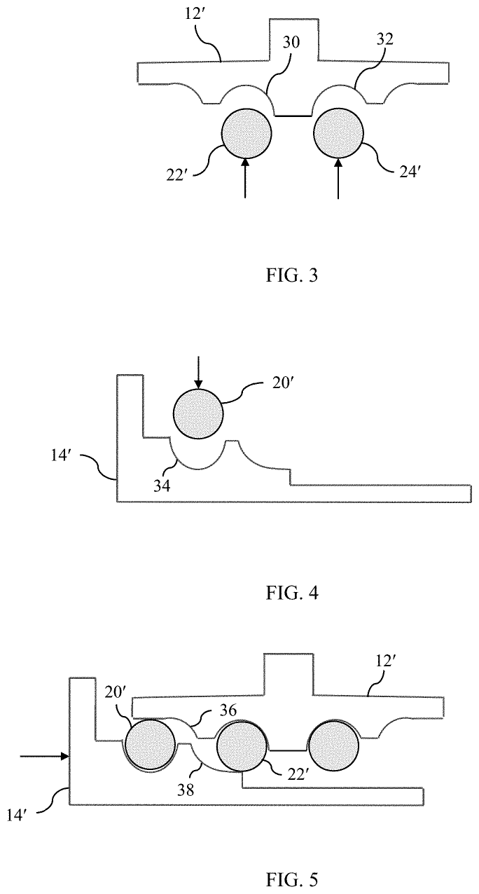

FIGS. 3 through 7 illustrate a process for assembling the bearing of FIG. 2. As shown in FIG. 3, the balls of the inner rows 22′ and 24′ are inserted radially into inner raceways 30 and 32 of the outer ring. Whereas all of the raceways in the bearing of FIG. 1 are roughly 90 degrees of a circle in cross section, the inner raceways 30 and 32 of the outer ring 12′ include considerably more than 90 degrees of a circle, continuing around the non-contact side of the balls to a radius less than Rₚₒ.

As shown in FIG. 4, the balls of the left outer row 20′ are inserted radially into raceway 34 of the first ring portion 14′ of the split inner ring. Raceway 34, like 30 and 32, includes considerably more than 90 degrees of a circle, continuing around the non-contact side of the balls to a radius greater than Rₚᵢ.

As shown in FIG. 5, after the leftmost three rows of balls have been inserted into respective raceways, the first ring portion 14′ is axially inserted into the outer ring 12′. Doing so causes the balls 20′ of the left outer row to come into contact a left outer raceway 36 of the outer ring. Also, the balls 22′ of the left inner row come into contact with inner raceway 38 of the first ring portion 14′.

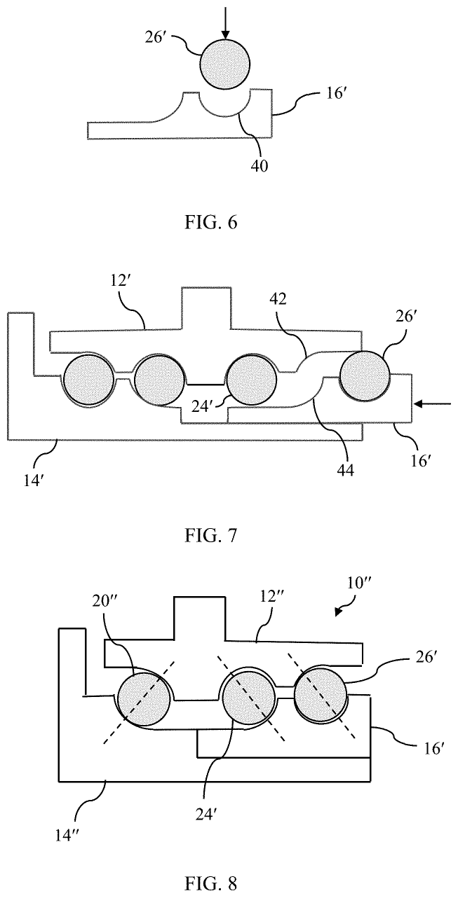

As shown in FIG. 6, the balls of the right outer row 26′ are inserted radially into raceway 40 of the second ring portion 16′ of the split inner ring. Raceway 40, like 30, 32, and 34, includes considerably more than 90 degrees of a circle, continuing around the non-contact side of the balls to a radius greater than Rₚᵢ.

Finally, as shown in FIG. 7, the second ring portion 16′ is axially inserted into the outer ring 12′ and mated with the first ring portion 14′. Doing so causes the balls 26′ of the right outer row to come into contact a right outer raceway 42 of the outer ring. Also, the balls 24′ of the right inner row come into contact with inner raceway 44 of the second ring portion 16′. Once the balls make the desired contact, the split ring portions 14′ and 16′ are squeezed together with a desired degree of preload and secured to one another in a manner that will maintain the preload.

FIG. 8 illustrates an improved three-row angular contact ball bearing 10″. Parts which fulfill the same function as a part in the bearing of FIG. 2, but are not identical, are labelled with a double primed reference number to indicate the correspondence. As in the design of FIG. 2, all rows of balls, 20″, 24′, and 26′, have the same radii. Furthermore, all of the rows have the same number of balls and therefore the same capacity. The lines of action of rows 24′ and 26′ are oriented in the same direction as each other but in an opposite direction from row 20″.

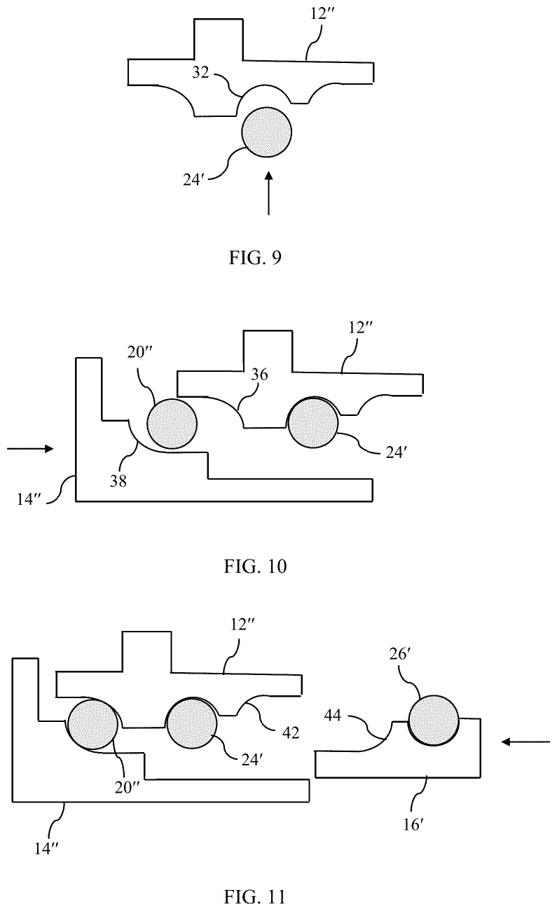

FIGS. 6 and 9-11 illustrate a process for assembling the bearing of FIG. 8. As shown in FIG. 9, the balls of the inner row 24′ are inserted radially into inner raceway 32 of the outer ring. As shown in FIG. 10, after the balls 24′ have been inserted, the first ring portion 14″ is axially inserted into the outer ring 12″. Balls 20″ of the left row are inserted between first ring portion and the outer ring. These balls may be inserted into either component and may be inserted radially or axially. As the first ring portion 14″ is axially inserted into the outer ring 12″, the balls 20″ come into contact with a left raceway 36 of the outer ring with raceway 38 of the first ring portion 14″.

The balls of the right outer row 26′ are inserted radially into raceway 40 of the second ring portion 16′ of the split inner ring as shown in FIG. 6. This step is identical between the three-row version and the four-row version. Finally, as shown in FIG. 11, the second ring portion 16′ is axially inserted into the outer ring 12″ and mated with the first ring portion 14″. Doing so causes the balls 26′ of the right outer row to come into contact a right outer raceway 42 of the outer ring and with inner raceway 44 of the second ring portion 16′. Once the balls make the desired contact, the split ring portions 14″ and 16′ are squeezed together with a desired degree of preload and secured to one another in a manner that will maintain the preload.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A multi-row bearing assembly comprising:
an outer ring defining first and second raceways;
a first inner ring defining third and fourth raceways;
a first row of rollers in angular contact with the first and third raceways, the rollers defining a first outer radius and a first outer pitch radius with respect to the first raceway; and
a second row of rollers in angular contact with the second and fourth raceways, the rollers defining a second outer radius and a second outer pitch radius with respect to the second raceway; wherein
lines of action of the first and second rows of rollers are oriented in the same direction;
the first outer radius exceeds the second outer pitch radius; and
the second outer radius exceeds the first outer pitch radius.

2. The multi-row bearing of claim 1, wherein the rollers are balls.

3. The multi-row bearing of claim 1, wherein the first row of rollers contains a same number of rollers as the second row of rollers.

4. The multi-row bearing of claim 1, wherein:
the first row of rollers further defines a first inner radius and a first inner pitch radius with respect to the third raceway; and
the second row of rollers further defines a second inner radius and a second inner pitch radius with respect to the fourth raceway;
the first inner pitch radius exceeds the second inner radius; and
the second inner pitch radius exceeds the first inner radius.

5. The multi-row bearing of claim 4 wherein:
the first inner radius is equal to the second inner radius; and
the first outer radius is equal to the second outer radius.

6. The multi-row bearing of claim 4 further comprising:
a second inner ring defining a fifth raceway; and
a third row of rollers in angular contact with the fifth raceway and a sixth raceway defined by the outer ring, the rollers defining a third outer radius, a third inner radius, a third inner pitch radius with respect to the fifth raceway, and a third outer pitch radius with respect to the sixth raceway; wherein
a line of action of the third row of rollers is oriented in an opposite direction from the lines of action of the first and second rollers.

7. The multi-row bearing of claim 6 further comprising:
a fourth row of rollers in angular contact with a seventh raceway defined by the second inner ring and with an eighth raceway defined by the outer ring, the rollers defining a fourth outer radius, a fourth inner radius, a fourth inner pitch radius with respect to the seventh raceway, and an fourth outer pitch radius with respect to the eighth raceway; wherein
a line of action of the fourth row of rollers is oriented in an opposite direction from the lines of action of the first and second rollers;
the third outer radius exceeds the fourth outer pitch radius;
the fourth outer radius exceeds the third outer pitch radius;
the third inner pitch radius exceeds the fourth inner radius; and
the fourth inner pitch radius exceeds the third inner radius.

8. The multi-row bearing of claim 6 wherein one of the first ring portion and the second ring portion includes a flange adapted for mounting a vehicle wheel.

9. A multi-row bearing assembly comprising:
a single-piece ring defining first, second, and third raceways;
a split ring having first and second ring portions, the first ring portion defining fourth and fifth raceways, the second ring portion defining a sixth raceway;
a first row of rollers in angular contact with the first and fourth raceways;
a second row of rollers in angular contact with the second and fifth raceways; and
a third row of rollers in angular contact with the third and sixth raceways; wherein
lines of action of the first and second rows of rollers are oriented in an opposite direction from a line of action of the third row of rollers;
each row of rollers defines an inner and an outer pitch radius with respect to corresponding raceways; and
each row defines an inner radius and an outer radius, each outer radius greater than all of the outer pitch radii, each inner radius less than all of the inner pitch radii.

10. The multi-row bearing of claim 9, wherein the rollers are balls.

11. The multi-row bearing of claim 9, wherein the first, second, and third rows of rollers each contains a same number of rollers.

12. The multi-row bearing of claim 9 wherein:
the inner radii of each of the rows or rollers are equal to one another; and
the outer radii of each of the rows or rollers are equal to one another.

13. The multi-row bearing of claim 9 further comprising:
a fourth row of rollers in angular contact with a seventh raceway defined by the single piece ring and with an eighth raceway defined by the second ring portion; wherein
a line of action of the fourth row of rollers is oriented in an opposite direction from the lines of action of the first and second rollers;
the fourth row of rollers defines an outer radius greater than all of the outer pitch radii; and
the fourth row of rollers defines an inner radius less than all of the inner pitch radii.

14. The multi-row bearing of claim 9 wherein one of the first ring portion and the second ring portion includes a flange adapted for mounting a vehicle wheel.

15. A method of assembling a multi-row angular contact bearing, the method comprising:
inserting a first set of rollers radially into a first raceway of a single piece ring;
inserting a second set of rollers radially into a second raceway of a first ring portion of a split ring; and
axially bringing together the single piece ring and the first ring portion such that the first set of rollers comes into contact with a third raceway defined in the first ring portion and the second set of rollers comes into contact with a fourth raceway defined in the single piece ring.

16. The method of claim 15 further comprising:
axially mating a second ring portion of the split ring to the first ring portion such that a third row of rollers) comes into contact with a fifth raceway defined in the single-piece ring and with a sixth raceway defined in the second ring portion.

17. The method of claim 15 further comprising:
inserting a third set of rollers radially into a fifth raceway of the single piece ring;
inserting a fourth set of rollers radially into a sixth raceway of a second ring portion of the split ring; and
axially mating the second ring portion and the first ring portion such that the third set of rollers comes into contact with a seventh raceway defined in the second ring portion and the fourth set of rollers comes into contact with an eighth raceway defined in the single piece ring.

18. The method of claim 15 wherein the rollers are balls.
